(19) United States
(12) Patent Application Publication
(10) Pub. No.: US 2021/0370438 A1
(43) Pub. Date: Dec. 2, 2021

(54) LASER PROCESSING DEVICE

(71) Applicant: Panasonic Intellectual Property Management Co., Ltd., Osaka (JP)

(72) Inventors: KAZUKI FUJIWARA, Osaka (JP); KOJI FUNAMI, Kyoto (JP)

(21) Appl. No.: 17/314,083

(22) Filed: May 7, 2021

(30) Foreign Application Priority Data
May 26, 2020 (JP) 2020-091551

(51) Int. Cl. B23K 26/06; B23K 26/0622; B23K 26/035; B23K 26/04

(52) U.S. Cl. CPC B23K 26/0643; B23K 26/0648; B23K 26/04; B23K 26/035; B23K 26/0622

(57) ABSTRACT

A laser processing device which irradiates a workpiece while scanning focused laser light and forms molten region on a surface of workpiece includes first optical sensor which has a function of detecting light generated from molten region during irradiation with the laser light, the detecting is performed for first measurement region on the surface of workpiece as a detection target, and second optical sensor which has a function of detecting light generated from molten region during irradiation with the laser light, the detecting is performed for second measurement region narrower than first measurement region on the surface of workpiece as a detection target.

### BACKGROUND

### 1. Technical Field

The present disclosure relates to a laser processing device capable of monitoring a laser processing state.

### 2. Description of the Related Art

Laser welding technology is a technology which irradiates a workpiece with laser light emitted from a laser oscillator, melts the workpiece with the amount of heat of the laser light, and welds the workpiece to another workpiece to mechanically and/or electrically couple these workpieces. Laser welding technology is generally widespread in a wide range of fields such as home appliances, precision apparatuses, and automobile components.

In such laser welding technology, various adjustment items are generally adjusted by trial and error according to the shape and size of each laser oscillator or a workpiece, but there is a case where such trial and error adjustments cannot respond to a case where a processed product of a predetermined quality cannot be obtained.

Japanese Patent Unexamined Publication No. 2017-164801 discloses that quality determination is made by comparing the measurement value of the internal information of a processing device with the threshold value set in the provisional determination portion, and the quality with the actual processed product is fed back to update the threshold value of the provisional determination portion.

### SUMMARY

A laser processing device according to the present disclosure which irradiates a workpiece while scanning focused laser light and forms a molten region on a surface of the workpiece, includes a first light detector which has a function of detecting light generated from the molten region during irradiation with the laser light, the detecting is performed for a first measurement region on the surface of the workpiece as a detection target, and a second light detector which has a function of detecting light generated from the molten region during irradiation with the laser light, the detecting is performed for a second measurement region narrower than the first measurement region on the surface of the workpiece as a detection target.

### BRIEF DESCRIPTION OF THE DRAWINGS

FIG. 1 is a block view illustrating a configuration of a laser processing device according to an exemplary embodiment of the present disclosure;

FIG. 2A is an explanatory view illustrating the relationship between molten region M and measurement regions Q1 and Q2;

FIG. 2B is an enlarged view of FIG. 2A; and

FIG. 3 is an explanatory view illustrating an example of the correlation between an amount of thermal radiation light and a welding quality, (A) is a graph illustrating the time change of the amount of thermal radiation light, and (B) is a graph illustrating the time change of a laser output.

### DETAILED DESCRIPTION

In the evaluation method of a processing result disclosed in Japanese Patent Unexamined Publication No. 2017-164801, the processing result is evaluated after processing, and it takes time to obtain the processing result. Further, the evaluation method of the processing result disclosed in Japanese Patent Unexamined Publication No. 2017-164801, although the processing result is acquired after the processing and the processing result can be detected as abnormal, the cause cannot be identified, so that it takes time and effort to deal with the abnormality.

In view of the problems in related art mentioned above, an object of the present disclosure is to provide a laser processing device capable of monitoring a laser processing state quickly and with high accuracy.

A laser processing device according to the present disclosure which irradiates a workpiece while scanning focused laser light and forms a molten region on a surface of the workpiece, includes a first light detector which has a function of detecting light generated from the molten region during irradiation with the laser light and detects a first measurement region on the surface of the workpiece as a detection target, and a second light detector which has a function of detecting light generated from the molten region during irradiation with the laser light and detects a second measurement region narrower than the first measurement region on the surface of the workpiece as a detection target.

According to the laser processing device according to the present disclosure, the laser processing state can be monitored quickly and with high accuracy.

### 1. Device Configuration

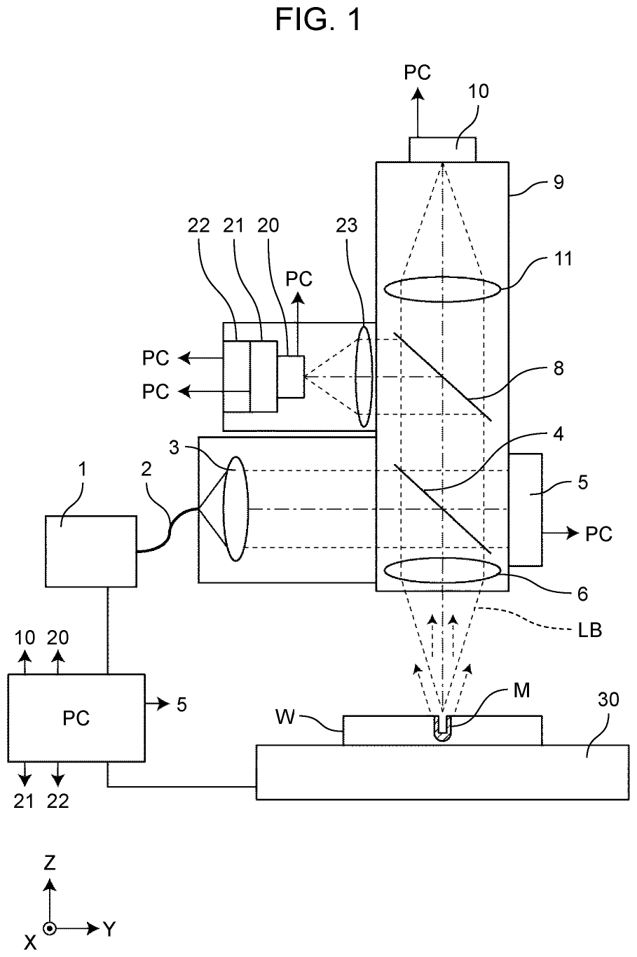

An exemplary embodiment of the present disclosure will be described with reference to the drawings. FIG. 1 is a block view illustrating a configuration of a laser processing device according to an exemplary embodiment of the present disclosure. Laser processing is a method of performing welding, cutting, perforation, marking, surface treatment, etching, deposition, or the like using laser light. Here, laser welding is illustrated, but the present disclosure is not limited thereto.

The laser processing device includes laser oscillator 1, optical fiber 2 for transmitting laser light, collimating lens 3, partial reflection mirror 4, and condenser lens 6 as a laser light supply unit, and laser output sensor 5, partial reflection mirror 8, condenser lens 11, first optical sensor 10, condenser lens 23, and second optical sensor 20 as a light detection unit. Many of these components can be accommodated inside lens barrel 9.

The laser processing device further includes processing stage 30 which supports workpiece W and calculator PC which controls the entire device.

Laser oscillator 1 is constituted with, for example, a gas laser such as a carbon dioxide gas laser, and a solid-state laser such as a YAG laser, a semiconductor laser, or a fiber laser, and generates a laser light having a predetermined wavelength and a predetermined output. As an example, the laser light is a continuous wave (CW) having a wavelength of 1070 nm. It is possible to select an optimum laser wavelength according to the light absorption characteristics of workpiece W, and for example, when workpiece W is copper Cu or gold Au, it is preferable that the laser wavelength is a relatively short wavelength such as 405 to 450 nm. Further, when workpiece W is aluminum, it is preferable that the laser wavelength is a wavelength of approximately 800 nm because the light absorption characteristics are good and excellent welding is possible.

Here, a case where a continuous wave is used as the laser light is illustrated, but a laser light of a pulse wave may be used. When a laser light of a continuous wave is used, it is preferable in that productivity increases because the amount of heat input to workpiece W can be increased. Further, when the laser light of the pulse wave is used, it is preferable in that the thermal influence at the time of processing can be reduced as compared with the continuous wave.

Laser oscillator 1 is communicatively connected to calculator PC, can control the output of the laser light in response to a command from calculator PC, and can also control the cycle and the duty cycle in the case of a pulse wave.

Optical fiber 2 for laser light transmission has a function of transmitting the laser light from laser oscillator 1 to the inside of lens barrel 9. As an alternative to optical fiber 2, the laser light emitted from laser oscillator 1 can be guided to lens barrel 9 by using an optical element such as a mirror.

Collimating lens 3 converts the laser light emitted from optical fiber 2 into a parallel light beam.

Partial reflection mirror 4 has a function of reflecting most of the light beam from optical fiber 2 and transmitting a portion of the light beam. As an example, in partial reflection mirror 4, a mirror such as a dichroic mirror which reflects light in a specific wavelength range and transmits light in a different wavelength range can be used. Partial reflection mirror 4 can select desired optical characteristics according to the reflection wavelength or the transmission wavelength, and the ratio of the transmitted light amount to the reflected light amount may be changed as necessary. The light beam which has passed through partial reflection mirror 4 is received by laser output sensor 5 which monitors the output of the laser light. Laser output sensor 5 includes a photodiode, an A/D converter, or the like, and is communicably connected to calculator PC, and the detection signal thereof is input to calculator PC.

Condenser lens 6 focuses the laser light reflected by partial reflection mirror 4 to form light beam LB, and forms a light spot having a predetermined shape on the surface of workpiece W. A large amount of heat energy is applied to the irradiation region of the light spot, and the portion which has exceeded a melting point becomes molten region M, for example, welding workpiece W.

Processing stage 30 is constituted with an XYZθ table or the like and is communicably connected to calculator PC, and the three-dimensional position of workpiece W and the angle around the optical axis of light beam LB can be controlled according to a command from calculator PC.

When scanning workpiece W with light beam LB, 1) a method in which lens barrel 9 and light beam LB are fixed and processing stage 30 is moved in a predetermined direction at a predetermined speed, 2) a method in which lens barrel 9 is mounted on a scanning mechanism such as a robot arm or a linear stage, and lens barrel 9 is moved in a predetermined direction at a predetermined speed while processing stage 30 is fixed, 3) a method of installing an optical scanner, for example, a galvano mirror or the like between condenser lens 6 and workpiece W, and 4) a combination of the above methods 1) to 3) or the like can be used.

Calculator PC is constituted with a computer including a processor, a memory, a mass storage, or the like, and executes various operations according to a preset program.

In the present exemplary embodiment, first optical sensor 10 and second optical sensor 20 are installed to detect at least one of light generated from molten region M during irradiation with laser light, for example, a) thermal radiation light emitted from molten region M, b) visible light emitted from molten region M, and c) the reflected light reflected from workpiece W.

A portion of the light generated from molten region M is incident on condenser lens 6, passes through partial reflection mirror 4, and is incident on partial reflection mirror 8. Partial reflection mirror 8 has a function of reflecting and transmitting incident light at a predetermined ratio. As an example, partial reflection mirror 8 can use a half mirror having no wavelength dependence. As another example, partial reflection mirror 8 can use a dichroic mirror having a wavelength dependence, may have a wavelength dependence as necessary, and may change the ratio of the transmitted light amount to the reflected light amount.

The light which has passed through partial reflection mirror 8 is received by first optical sensor 10 through condenser lens 11. First optical sensor 10 has a function of detecting light generated from molten region M during irradiation with laser light, and detects a first measurement region on the surface of workpiece W as a detection target. This first measurement region will be described later. First optical sensor 10 includes a photodiode, A/D converter, or the like, and is communicably connected to calculator PC, and the detection signal thereof is input to calculator PC.

The light which has been reflected from partial reflection mirror 8 is received by second optical sensor 20 through condenser lens 23. Second optical sensor 20 has a function of detecting light generated from molten region M during irradiation with the laser light, and detects a second measurement region, which is narrower than the first measurement region, on the surface of workpiece W as a detection target. This second measurement region will be described later. Second optical sensor 20 includes a photodiode, an A/D converter, or the like, and is communicably connected to calculator PC, and the detection signal thereof is input to calculator PC.

Second optical sensor 20 is mounted on X stage 21 and Y stage 22 which can be positioned in a direction perpendicular to the optical axis of the incident light. X stage 21 and Y stage 22 are communicably connected to calculator PC, and the position of second optical sensor 20 can be controlled in response to a command from calculator PC, so that the second measurement region on the surface of workpiece W becomes movable. In other words, X stage 21 and Y stage 22 act as a position controller which controls the position of second optical sensor 20 so that the second measurement region can move on the surface of workpiece W. As described above, workpiece W may be scanned by light beam LB. X stage 21 and Y stage 22 may control the position of second optical sensor 20 so that the second measurement region can move on the surface of workpiece W following the scanning of light beam LB. As a result, the positional relationship between the irradiation position of light beam LB and the second measurement region is maintained during the scanning of light beam LB.

As the thermal radiation light to be measured, light having a wavelength of 1300 nm can be used as an example. In that case, when workpiece W is irradiated with the laser light, the thermal radiation light is emitted from molten region M. Such thermal radiation light passes through partial reflection mirror 4 via condenser lens 6, is divided by partial reflection mirror 8, and is incident on first optical sensor 10 and second optical sensor 20. Accordingly, partial reflection mirror 4 is formed with a reflective film having wavelength selectivity which reflects the laser light and transmits only the thermal radiation light.

When visible light is to be measured at the same time as thermal radiation light, it is possible to detect visible light in the same way as thermal radiation light by, for example, forming a wavelength-selective reflective film which also transmits visible light on partial reflection mirror 4, adding a mirror on which a wavelength-selective reflective film that reflects only visible light is formed in front of the optical sensor which measures thermal radiation light, and installing an optical sensor for visible light.

Further, when the reflected light from workpiece W is to be measured at the same time as the thermal radiation light, it is possible to detect visible light as well as thermal radiation light by, for example, installing an optical sensor for reflected light outside the optical path between partial reflection mirror 4 and collimating lens 3.

When measuring thermal radiation light, visible light, and reflected light, these may be measured at the same time, or a plurality of wavelengths may be measured. This makes it possible to grasp information in more detail from light of various wavelengths generated during welding. In that case, it is desirable to select the wavelength region of the mirror or lens according to the wavelength to be measured.

As for a photodetector used as an optical sensor, it is desirable to use one having high sensitivity according to the wavelength range to be measured.

When detecting thermal radiation light, a bandpass filter which selectively transmits light having a wavelength of 1300 nm may be disposed on the optical path until the light is incident on the optical sensor. Accordingly, light of an unnecessary wavelength other than thermal radiation light is prevented from being incident on the optical sensor, and it is possible to measure the amount of thermal radiation light more accurately.

### 2. Plurality of Measurement Regions

First optical sensor 10 detects the first measurement region on the surface of workpiece W as a detection target. Second optical sensor 20 detects the second measurement region narrower than the first measurement region on the surface of workpiece W as a detection target. Accordingly, second optical sensor 20, for example, can use a detection element having a smaller light receiving area as compared with first optical sensor 10, or can adopt a method of providing an aperture having an opening smaller than an opening of first optical sensor 10 to physically limit a measurement area. As such an aperture, an aperture whose opening diameter can be changed may be used.

Further, as another method of changing the measurement region, a method of setting the focal lengths of condenser lenses 11 and 23 to be different may be used. For example, when the focal length of condenser lens 23 for second optical sensor 20 is 200 mm and the focal length of condenser lens 11 for first optical sensor 10 is set to 100 mm, twice the measurement region can be secured although the detection elements have the same size. In this way, the focal lengths of condenser lenses 11 and 23 may be adjusted according to the desired measurement region.

Further, the positional relationship between first optical sensor 10 and second optical sensor 20 may be any position as long as the sensors can detect the light transmitted through and reflected by partial reflection mirror 8, respectively.

The first measurement region of first optical sensor 10 and the second measurement region of second. optical sensor 20 preferably include a welding width in molten region M. Accordingly, the desired welding is performed on workpiece W, and the welding shape at the time of processing is confirmed by using a microscope or the like. Regarding the measurement resolution, it is desirable that the measurement can be performed with an accuracy of 1/100 or less of the shape to be measured. After measuring the welding shape and confirming the welding width, the second measurement region of second optical sensor 20 is limited by an aperture, a condenser lens, or the like according to the welding width.

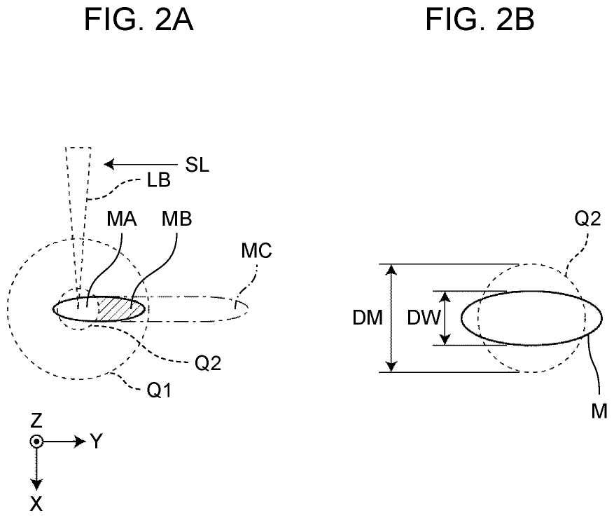

FIG. 2A is an explanatory view illustrating the relationship between molten region M and measurement regions Q1 and Q2, and FIG. 2B is an enlarged view thereof. Light beam LB is incident perpendicularly on the paper surface and moves with respect to workpiece W along laser scanning direction SL.

Here, a case of detecting thermal radiation light will be described as an example. In general, since the amount of thermal radiation light has a high correlation with the processing temperature, detecting the amount of thermal radiation light is used to measure the temperature of molten region M. In the welding processing, the influence of the surface condition, the unevenness of the surface, or the like, and the spatter generated at the time of welding, or the like affect the signal strength of molten region M. Accordingly, it is desirable to measure the thermal radiation light from molten region M in real time during processing.

The detection of thermal radiation light is performed during the welding processing by the laser welding device described above.

As described above, molten region M is formed on the surface of workpiece W by irradiation with light beam LB, and includes molten region MA and molten region MB.

Molten region MA is a heat input region in which a portion of workpiece W is melted by the focused irradiation of light beam LB. Molten region MB is a pre-solidification region in which the irradiation of light beam LB is completed and the molten state is maintained. For example, when a metal melts, thermal radiation light due to blackbody radiation according to its high temperature and inherent emission due to photoexcitation and relaxation of a metal element, for example, visible light, are generated.

Solidification region MC is a region in which molten region MB is cooled and solidified over time after laser irradiation, as illustrated by the alternate long and short dash line in FIG. 2A. In the region, thermal radiation light and visible light generated at the time of melting are attenuated, and light detection is difficult or impossible.

As illustrated in FIG. 2B, welding width DW corresponds to the welding width of molten region M, and is a welding dimension generated in a direction perpendicular to laser scanning direction SL.

Returning to FIG. 2A, first measurement region Q1 is the detection target of first optical sensor 10 and is set as a range which sufficiently includes a region necessary for temperature measurement of molten region MA. That is, first measurement region Q1 is set to a region wider than molten region MA. First measurement region Q1 is generally set as a circular region, but may have an elliptical shape, a rectangular shape, or any other shape.

In the present exemplary embodiment, first measurement region Q1 is a circular region having a diameter of approximately 5 to 10 mm centered on the center position of the laser irradiation area, but it may be configured to include a region on which thermal radiation light can be detected, and it is preferable to change the measurement region according to the welding shape. For example, when the welding shape is large or the laser output is high, it is possible to actually perform processing, observe the processing portion, grasp the melting shape, and then determine the measurement region. For observing molten region MB, for example, it is possible to detect molten region MB with high accuracy by photographing a molten region before solidification using a high-speed camera or the like. At that time, for example, the measurement region may be set by physically limiting the measurement region, for example, by providing an aperture in front of first optical sensor 10. Accordingly, it is possible to detect the light generated in the portion in which the molten state continues after the irradiation of light beam LB is completed.

As will be described later, first measurement region Q1 is preferably used for grasping the overall behavior in one welding processing. Accordingly, it is preferable that first measurement region Q1 is set to include the entire processed region in continuous welding processing. In this case, since it is set to include a region such as solidification region MC which has already solidified and the thermal radiation light may not be detected, it is conceivable that the accuracy of the signal waveform of the measured thermal radiation light may decrease. Accordingly, it is more preferable that first measurement region Q1 is set to include at least the entire region in which melting occurs during processing, such as molten region MB.

Second measurement region Q2 is the detection target of second optical sensor 20, and is set as a range including the irradiation area of light beam LB and welding width DW. That is, second measurement region Q2 is narrower than first measurement region Q1 and is a region for acquiring temperature information of molten region M and its vicinity. Second measurement region Q2 is generally set as a circular region, but may have an elliptical shape, a rectangular shape, or any other shape.

As illustrated in FIG. 2B, second measurement region Q2 has measurement width DM in a direction perpendicular to laser scanning direction SL.

When welding is performed by laser scanning, light is emitted according to the input energy even in molten region MB at which the irradiation of light beam LB is completed. Accordingly, it is difficult to grasp the molten state outside the irradiation region only in a narrow measurement region. Accordingly, by setting a region wider than molten region M as the detection target of the thermal radiation light, it is possible to detect a phenomenon generated at the time of melting, for example, the generation of spatter, the influence of the melting liquid generated until the solidification after the laser light irradiation is performed, or the like. First measurement region Q1 plays this role.

On the other hand, in order to obtain a more detailed processing state at the time of welding such as detailed information on the welding shape, it is preferable to monitor the behavior of thermal radiation light from molten region M immediately after laser irradiation, and it is desirable to perform. measurement with further increased sensitivity by increasing the ratio of the melting vicinity location in the measurement region. Accordingly, it is possible to obtain more detailed information on the welding state by making the measurement region smaller and acquiring the temperature information of molten region M and its vicinity. Second measurement region Q2 plays this role.

The detection of thermal radiation light largely reflects the state of molten region M. Accordingly, for example, it is possible to acquire the signal strength according to the shape of molten region M by measuring the thermal radiation light in real time under a specific processing condition. When the shape of molten region M, for example, welding width DW or the welding length is changed, the strength value of the detection signal is different according to welding width DW or the welding length which has been changed. That is, the signal strength detected from molten region M also changes according to the change in the area of molten region M. By utilizing this, it is possible to estimate the shape of molten region M from the measured amount of thermal radiation light, and to grasp that there is a difference from the shape originally desired to be processed. For example, the welding condition can be more precisely grasped by measuring or calculating the thermal radiation light at the time of welding with desired melting width DW to store the value as a reference database, and then comparing the value with the measurement value of the thermal radiation light in the actual. welding processing. In this way, by making the measurement region smaller, it is possible to measure the temperature information at a specific position with high accuracy.

Further, in welding processing, the thermal radiation light in the vicinity of molten region M most reflects the processing condition, but a welding abnormality which can be detected in a region other than the vicinity of molten region M may also occur, for example, spatter or the like generated in a direction away from molten region M. Such a welding abnormality generates an influence on the thermal radiation light generated by a factor other than the welding state of molten region M. By utilizing this, it is possible to grasp that a welding abnormality has occurred by detecting thermal radiation light. For example, it is possible to determine the presence or absence of a peak in the waveform of thermal radiation light and determine the presence or absence of a welding abnormality. In this way, by making the measurement region larger, it is possible to measure the condition in the entire welding processing with high accuracy.

It is desirable that second measurement region Q2 always acquires temperature information of molten region M and its vicinity during processing. Accordingly, it is preferable that second measurement region Q2 moves in real time with the movement of the laser light by using X stage 21 and Y stage 22 as illustrated in FIG. 1. Specifically, calculator PC may drive X stage 21 and/or Y stage 22 in synchronization with acquiring displacement amount of processing stage 30 and/or lens barrel 9.

These calculations or estimates can be performed for each of first measurement region Q1 and second measurement region Q2. Specifically, the welding abnormality can be determined based on the measurement result in first measurement region Q1 which has a wider measurement region and is set to include the entire welding processing. The welding state can be precisely determined based on the measurement result in second measurement region Q2 which has a narrower measurement region and is set in the vicinity of molten region M. Accordingly, by measuring the thermal radiation light from molten region M and its vicinity and the thermal radiation light from a wider region than the region, it is possible to evaluate the processing state of the entire welding processing with higher accuracy.

It is possible to detect the measurement result based on the melting area by measuring the signal strength from first measurement region Q1 and second measurement region Q2 during laser processing and then measuring welding width DW of the welding portion after the laser processing is completed, and associating the signal strength value with the measurement value of welding width DW. Specifically, the time which contributes to the processing may be calculated and associated by dividing the welding length after processing workpiece W by the processing speed with respect to the measurement time of the signal strength acquired from first and second optical sensors 10 and 20.

As conditions for changing welding width DW and length of the welding portion, the output of the laser light is increased or decreased, the spot diameter is changed due to the fluctuation of the focal position of the laser light, and in the case of superposition welding, the light is scattered at a gap portion when a gap is generated, so that the shape of molten region M may also be changed and welding width DW may become narrow. The fluctuation of welding width DW is reflected in the signal strength as an area. Such changes in the welding shape can be measured by detecting the light from molten region M, but by performing detection in the measurement region having a dimension closer to welding width DW, it is possible to improve the detection accuracy with respect to the fluctuation of welding width DW.

As a condition at that time, it is preferable that the lower limit of measurement width DM is 1.25 times inciting width DW, and the upper limit of measurement width DM is radius RC of the circumscribed. circle of molten region MB before solidification centered on the irradiation position of the laser light. That is, it is preferable that radius R1 of first measurement region Q1 satisfy the following expression.

1.25×DW≤R1≤RC

Accordingly, it is possible to improve the detection accuracy of the welding state.

Further, since the irradiation area of the laser light is within the range of second. measurement region Q2, it is possible to reflect the shape which changes in real time at the time of irradiation. Accordingly, it is possible to detect information of welding width DW and the welding length with higher accuracy. Since fluctuations in the welding width and the welding length generally have a large effect on joint strength, when measurement can be made with high accuracy, it is possible to reduce a defect such as joint detachment during welding and to lead to quality stabilization of a product.

The signal strength obtained by measuring second measurement region Q2 by second optical sensor 20 largely reflects the state and shape change of molten region M, and the signal strength fluctuation at the time of shape change is greatly represented in the ratio of the measurement data. On the other hand, since first measurement region Q1 includes both molten region MA and molten region MB, the signal strength measured in first measurement region Q1 has a small fluctuation due to the change in the melting shape. Accordingly, for example, by considering both the measurement value of first measurement region Q1 and the measurement value of second measurement region Q2, it is possible to improve the detection accuracy of the signal value due to the change in the melting shape.

For example, by adding measurement value S1 in first measurement region Q1 and measurement value S2 in second measurement region Q2 (S1+S2), synthetic data in which the fluctuation portion of the thermal radiation light due to the welding abnormality is strengthened, can be acquired. Further, by subtracting measurement value S2 of second measurement region Q2 from measurement value S1 of first measurement region Q1 (S1−S2), conversion data in which the fluctuation portion of the thermal radiation light due to the shape change is further strengthened, can be acquired.

Further, when the phenomenon in which the signal waveform changes occurs behind molten region M, the behavior of the waveform. fluctuation at the time of the shape change can be detected with high sensitivity by using second optical sensor 20, so that it is possible to isolate and detect the cause. For example, when spatter occurs, it is possible to detect the protrusion of melting metal from molten region M, which leads to further quality control. of the welding portion. As another example, it is possible to detect the occurrence of a phenomenon such as foreign matter mixed in the melting portion after laser light irradiation generated outside second measurement region Q2 or a sudden shape change of the molten region. Since the occurrence of these phenomena is mainly detected in first measurement region Q1, it can be estimated by comparing with the signal waveform detected in second measurement region Q2.

Further, it is possible to detect the occurrence of welding abnormality by using the data obtained by measuring first measurement region Q1 and second measurement region Q2, for example, for the threshold value determination.

Further, it is possible to perform specification and determination of the welding shape, or the like by using machine learning to learn the correlation between the signal waveforms measured by first optical sensor 10 and second optical sensor 20, and the measurement result of welding width DW. In this case, in a certain welding processing, for example, the welding results such as melting width DW, the melting length, and the presence or absence of welding defects are set as a teacher data set together with the signal waveforms measured by first optical sensor 10 and second optical sensor 20. The correlation between the signal waveform and the welding result is learned. Such machine learning may be executed on calculator PC, or may be executed on an external computer connected by a network.

Further, for example, it is possible to specify the cause of the defect phenomenon by associating the defect phenomenon with the measurement data and determining the threshold value. Further, machine learning is used to learn by associating the measurement data with the phenomenon which occurs during welding, so that it is possible to determine the state of molten region M more accurately, and it is possible to lead to an improvement activity of equipment and a processing condition by displaying it on the display. That is, machine learning is used to learn a specific factor of a welding defect and a physical quantity related to the welding state, for example, the signal waveform of thermal radiation light according to the present disclosure as a teacher data set, so that the correlation between the signal waveform and the factor of the welding defect can be learned.

Regarding a measurement method, there are the temperature of the processing portion, the amount of thermal radiation light from the processing portion, the amount of visible light of the processing portion, the amount of vibration of the workpiece, or the like, and a plurality of them may be selected and measured.

Regarding the number of measurement samples, since the sufficient number of samples is required to capture the tendency of the local value of the physical quantity such as the characteristics of the processing in the laser welding evaluation, for example, the curvature of the curve of the laser output profile, the sampling cycle (measurement cycle) of the physical quantity is preferably 1/100 or less of the sampling cycle for controlling the output of laser irradiation.

### 3. Measurement Result

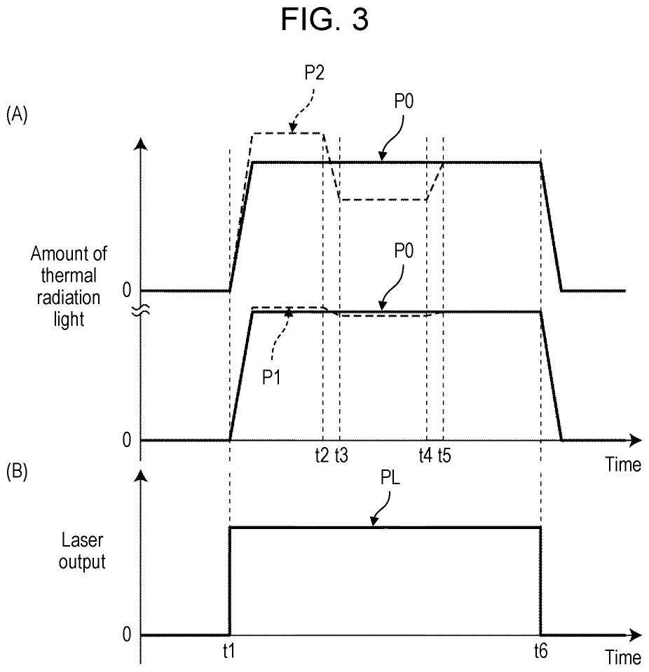

FIG. 3 is an explanatory view illustrating an example of the correlation between the amount of thermal radiation light and the welding quality. (A) of FIG. 3 is a graph illustrating the time change of the amount of thermal radiation light, and (B) of FIG. 3 is a graph illustrating the time change of the laser output.

Profile PL (B) of FIG. 3 illustrates the output of the laser light with which workpiece W is irradiated. Here, a case where the laser output is turned on at time t1 and is constant until time t6 is illustrated, but it is also possible to suppress spatter by changing the shape of profile PL over time according to the processing condition.

Profile P0 (solid line) in (A) of FIG. 3 illustrates the amount of thermal radiation light when appropriate welding is performed. For ease of comparison, in the upper graph, the profile is displayed while being superimposed on profile P2 (broken line) illustrating the change in the amount of thermal radiation light detected by second optical sensor 20. In the lower graph, the profile is displayed while being superimposed on profile P1 (broken line) illustrating the change in the amount of thermal radiation light detected by first optical sensor 10.

The laser output is turned on at time and the amount of thermal radiation light increases as the temperature of the laser irradiation region rises. When the temperature of the laser irradiation region rises further and the balance between the amount of heat input due to the laser light irradiation and the heat dissipation from the laser irradiation region to the periphery due to the heat conduction of workpiece W is equal, the temperature of the laser irradiation region is stable and the amount of thermal radiation light is constant. After that, when the laser irradiation is completed at time t6, the temperature of the laser irradiation region is lowered and the amount of thermal radiation light is reduced. By detecting such behavior of the amount of thermal radiation light, it is possible to determine whether a defect has occurred during laser welding. Further, when a peak is detected in profile P0, it can be determined that spatter has occurred. By confirming the behavior of the amount of thermal radiation light, it is possible to detect the occurrence of various abnormalities.

Next, profile P2 (broken line) illustrates a larger signal than profile P0, then greatly decreases from time t2 to time t3, increases again at time t4, and is constant at time t5. Since second measurement region Q2 of second optical sensor 20 is set to include molten region MA and not to include molten region MB, the detection sensitivity during laser processing is relatively high.

Next, profile P1 (broken line) illustrates a signal whose change is small as compared with profile P2. Since first measurement region Q1 is wider than second measurement region Q2, the detection sensitivity during laser processing decreases. Accordingly, when the detection accuracy in the vicinity of the processed region is reduced due to the influence of the disturbance on the detection signal, it is possible to detect the spatter generated in molten region MB and the welding abnormality generated in a region other than the vicinity of molten region M.

As for a cause of such welding abnormality, a defect cause in related art may be mentioned, for example, spatter generation, fume generation, plasma generation, laser output fluctuation, spot diameter fluctuation, laser irradiation time fluctuation, fluctuation caused by workpiece W, or the like.

Further, as an example of a welding defect, when spatter occurs, the spatter which jumps out from molten region M is a source of thermal radiation light other than molten region M, and the thermal radiation light emitted from the spatter is incident on condenser lens 6 and is detected by first optical sensor 10. At this time, an increase in the amount of thermal radiation light is observed as compared with profile P0 of the thermal radiation at the time of appropriate melting. Further, since the spatter is scattered at a high speed, it momentarily jumps out of the field of view of condenser lens 6, so that the increase in the detection signal appears as a peak shape. For example, when the spatter occurs, although it depends on the spatter size, the increase of the thermal radiation light intensity is observed at approximately 1.5 to 5 times as compared with the thermal radiation light intensity at the time of appropriate melting, and the peak originated from the spatter is observed.

Further, when irradiation is performed with light beam LB from the direction in which a plurality of workpieces W are superposed to perform superposition welding, it is preferable that workpieces W are brought into close contact with each other. The reason is that when there is a gap between workpieces W due to thermal deformation during laser welding, distortion remaining on workpiece W before processing, or the like, a problem occurs such as non-joint between workpieces W and insufficient strength of the joint portion. When there is a gap between workpieces W, molten region M penetrates one of workpieces W and comes out to the gap. Further, when a gap is generated, the laser light is scattered in the gap, so that the shape of molten region M also changes and the welding width is narrow. Accordingly, the intensity of thermal radiation light and reflected light is reduced.

Accordingly, in the case of superposition welding, it is possible to estimate the occurrence of a gap between workpieces W by the decrease in thermal radiation light intensity.

As described above, according to the present disclosure, it is possible to monitor the welding state with high accuracy by setting at least two measurement regions on the surface of the workpiece and detecting the light generated from the molten region. As a result, it is possible to evaluate the welding quality with high accuracy, and it is possible to predict the welding abnormality without depending on the skill level of the operator. Accordingly, it is possible to early respond to the abnormality, and it leads to the reduction of the number of defects, the reduction of device downtime, and the improvement of productivity.

The present disclosure is extremely useful industrially in that the laser processing state can be monitored quickly and with high accuracy.

What is claimed is:

1. A laser processing device which irradiates a workpiece while scanning focused laser light and forms a molten region on a surface of the workpiece, the laser processing device comprising:
a first light detector which has a function of detecting light generated from the molten region during irradiation with the laser light, the detecting is performed for a first measurement region on the surface of the workpiece as a detection target; and
a second light detector which has a function of detecting light generated from the molten region during irradiation with the laser light, the detecting being performed for a second measurement region narrower than the first measurement region on the surface of the workpiece as a detection target.

2. The laser processing device of claim 1,
wherein the second measurement region includes a heat input region in which a portion of the workpiece is melted by irradiation with the laser light, and the first measurement region includes the heat input region and at least a portion of a pre-solidification region in which the laser light irradiation is completed and a state of being melted is maintained.

3. The laser processing device of claim 1,
wherein the light generated from the molten region is at least one of thermal radiation light emitted from the molten region, visible light emitted from the molten region, and reflected light reflected from the workpiece.

4. The laser processing device of claim 1, further comprising:
a position controller which controls a position of the second light detector so that the second measurement region can move on the surface of the workpiece following scanning of the laser light.

5. The laser processing device of claim 1,
wherein the first measurement region includes a continuous processed region formed by continuous irradiation with the laser light.

6. The laser processing device of claim 1, further comprising:
a calculator which estimates a molten state of the molten region based on a first detection signal output from the first light, detector and a second detection signal output from the second light detector.

7. The laser processing device of claim 2,
wherein 1.25×DW≤R1≤RC is satisfied,
where DW is a melting width perpendicular to a scanning direction of the molten region,
RC is a radius of a circumscribed circle of the pre-solidification region centered on an irradiation position of the laser light, and
R1 is a radius of the first measurement region.
